(19) United States
(12) Patent Application Publication
(10) Pub. No.: US 2005/0081411 A1
(43) Pub. Date: Apr. 21, 2005

(54) Luggage identification tag systems and methods

(76) Inventor: Daniel Anthony Becker, Brookfield, WI (US)

Correspondence Address: RYAN KROMHOLZ & MANION, S.C., POST OFFICE BOX 26618, MILWAUKEE, WI, 53226, US

(21) Appl. No.: 10/850,576

(22) Filed: May 20, 2004

Related U.S. Application Data
(60) Provisional application No. 60/472,571, filed on May 22, 2003.

(51) Int. Cl. G09F 3/20

(52) U.S. Cl. 40/6

(57) ABSTRACT

A pop up container for containing baggage identification tags is provided. The baggage identification tags bear an indication of what airline a passenger is flying on, and also bear an advertisement for a third party.

### RELATED APPLICATION

This application claims the benefit of U.S. Provisional Patent Application Ser. No. 60/472,571, filed 22 May 2003, and entitled “Luggage Identification Tag Systems and Methods.”

### BACKGROUND OF THE INVENTION

This invention relates to the carriage checked baggage, preferably at an airport and comprises a novel baggage identification tag, and systems and methods for distributing and containing the same.

### SUMMARY OF THE INVENTION

Typically, airlines distribute baggage identification tags at the ticket counter, as a means for identifying checked baggage and correlating the baggage to an individual.

A novel combination of a baggage identification tag bearing an advertisement for a product tailored to a particular airline supplied demographic, and a container for holding said baggage identification tag, said container preferably a pop up point of sale display, bearing advertisements, and a method of procuring and brokering said advertisements.

### BRIEF DESCRIPTION OF THE VARIATIONS

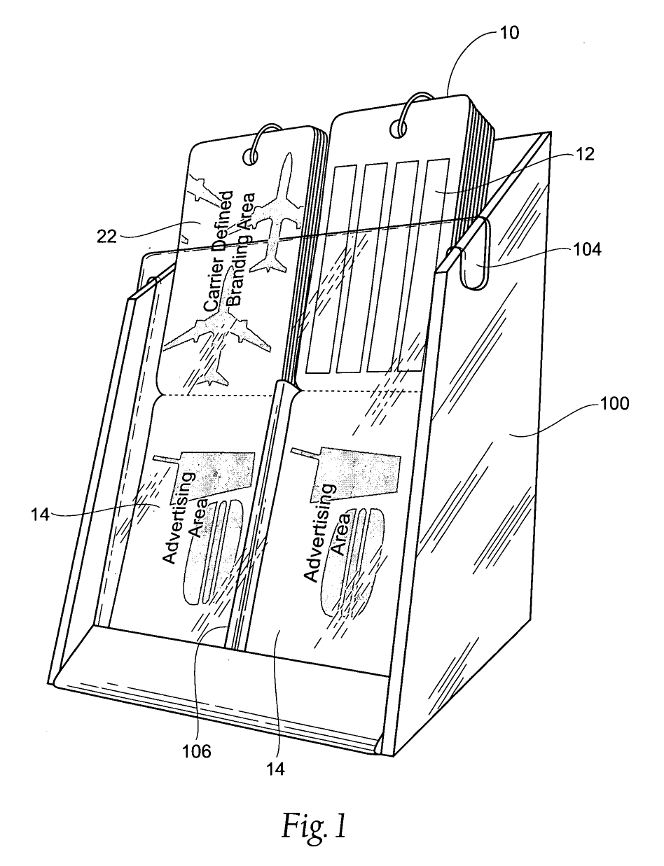

FIG. 1 is a perspective view of a container carrying baggage identification tags.

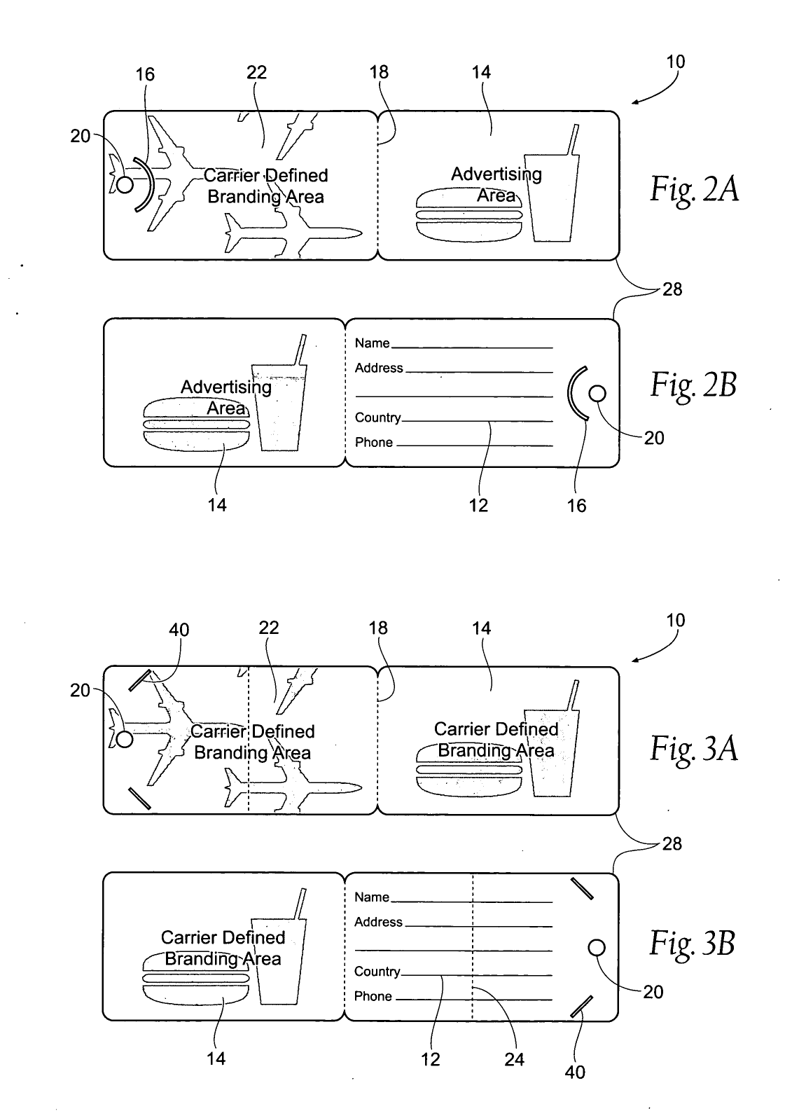

FIG. 2a is a first preferred embodiment of a front side of a baggage identification tag.

FIG. 2b is a first preferred embodiment of a rear side of a baggage identification tag.

FIG. 3a is a second preferred embodiment of a front side of a baggage identification tag.

FIG. 3b is a second preferred embodiment of a rear side of a baggage identification tag.

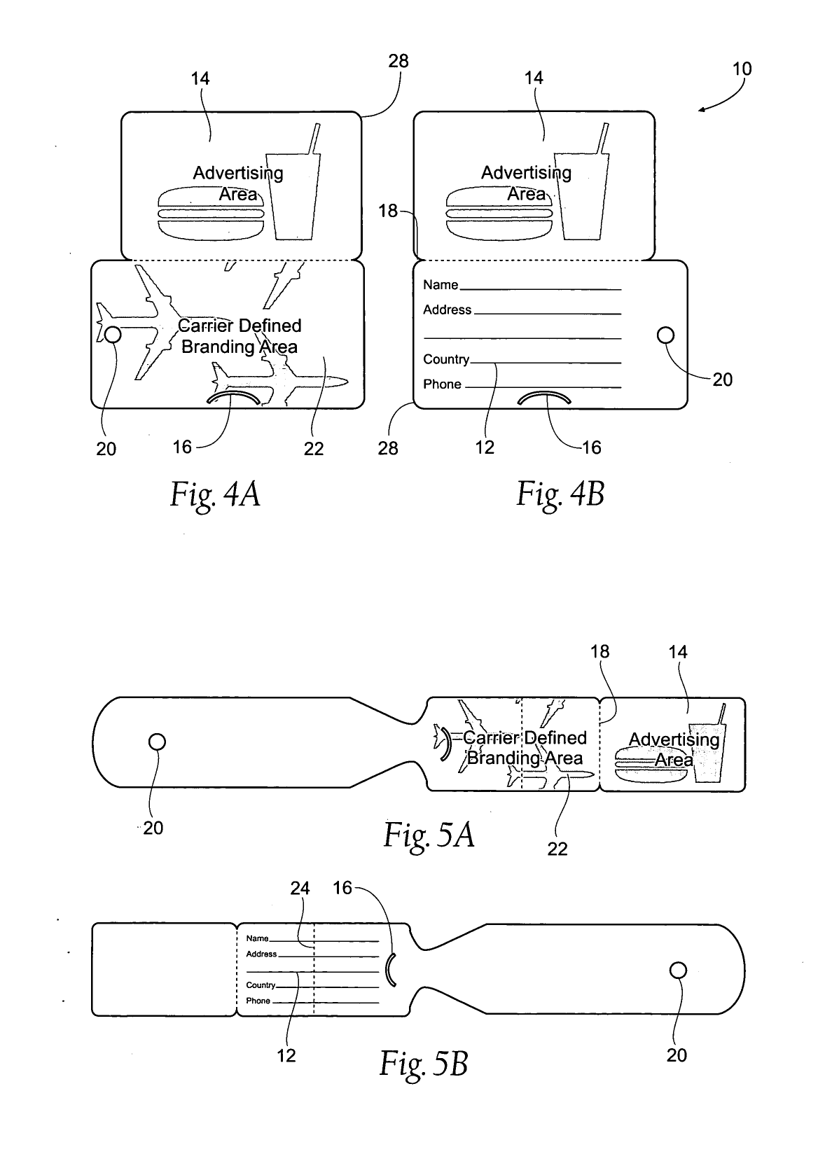

FIG. 4a is a third preferred embodiment of a front side of a baggage identification tag.

FIG. 4b is a third preferred embodiment of a rear side of a baggage identification tag.

FIG. 5a is a fourth preferred embodiment of a front side of a baggage identification tag.

FIG. 5b is a fourth preferred embodiment of a rear side of a baggage identification tag.

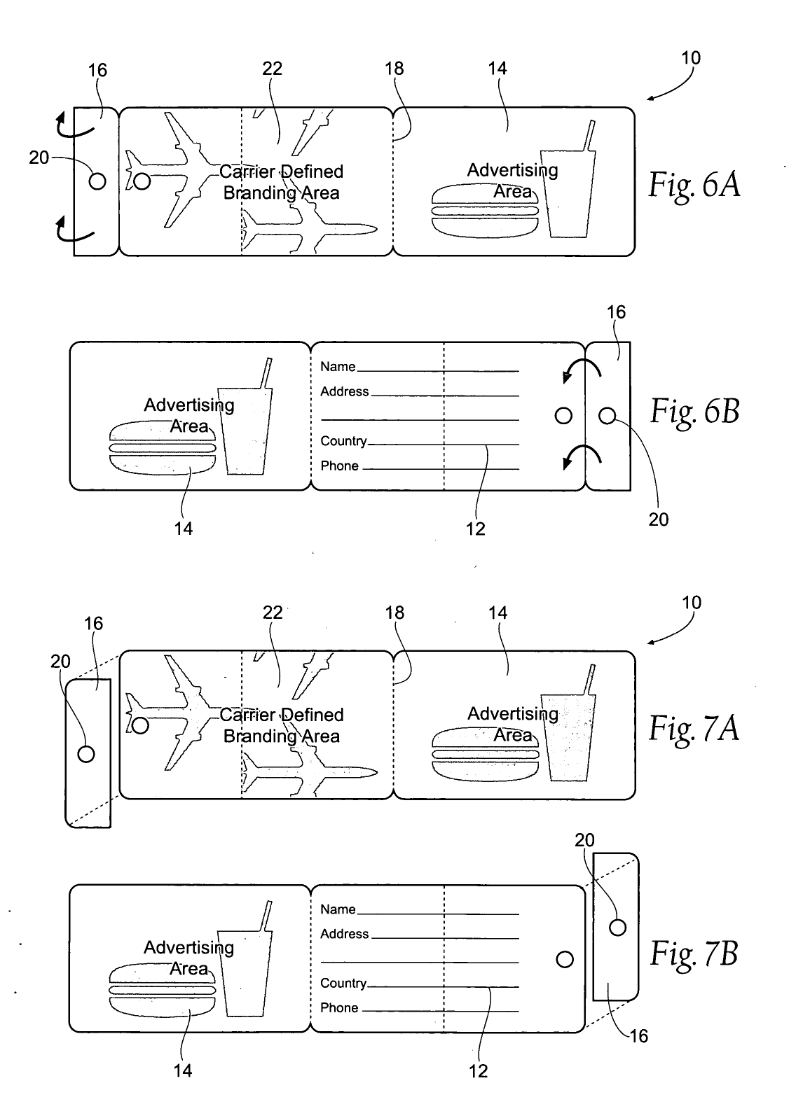

FIG. 6a is a fifth preferred embodiment of a front side of a baggage identification tag.

FIG. 6b is a fifth preferred embodiment of a rear side of a baggage identification tag.

FIG. 7a is a sixth preferred embodiment of a front side of a baggage identification tag.

FIG. 7b is a sixth preferred embodiment of a rear side of a baggage identification tag.

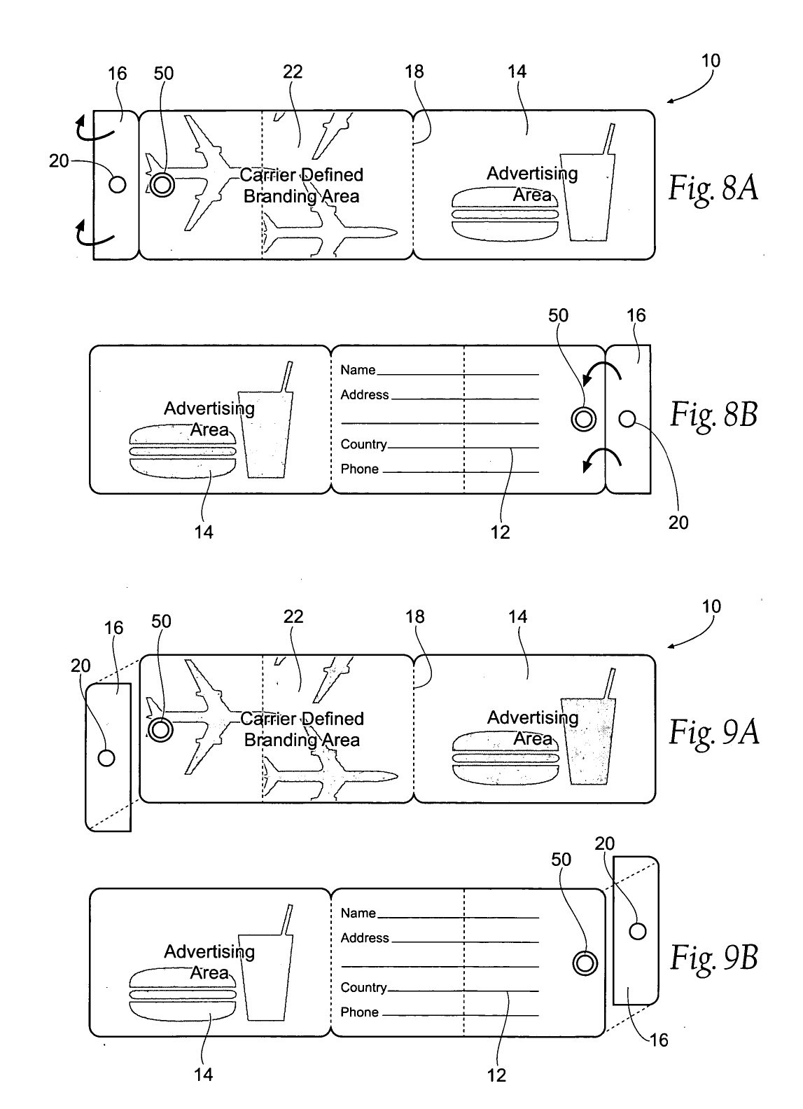

FIG. 8a is a seventh preferred embodiment of a front side of a baggage identification tag.

FIG. 8b is a seventh preferred embodiment of a rear side of a baggage identification tag.

FIG. 9a is an eighth preferred embodiment of a front side of a baggage identification tag.

FIG. 9b is an eighth preferred embodiment of a rear side of a baggage identification tag.

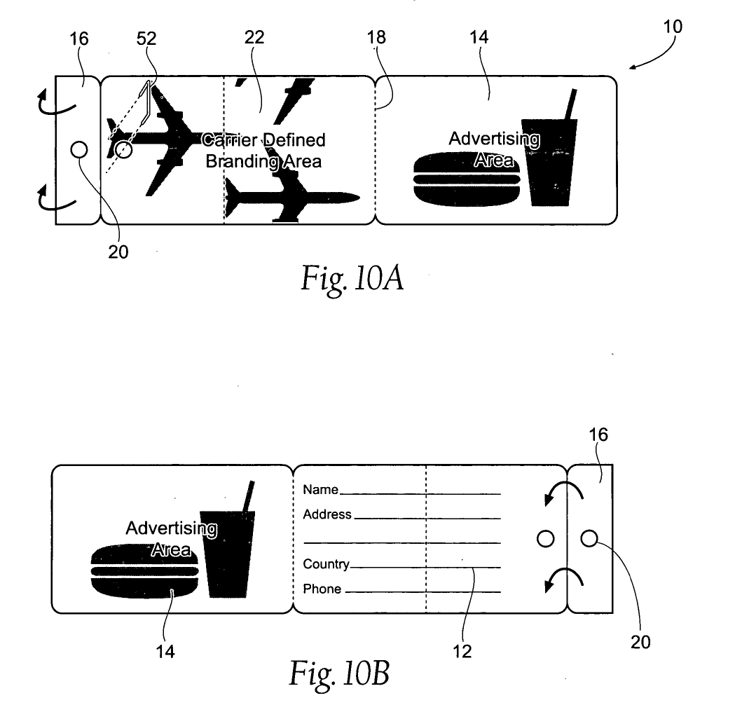

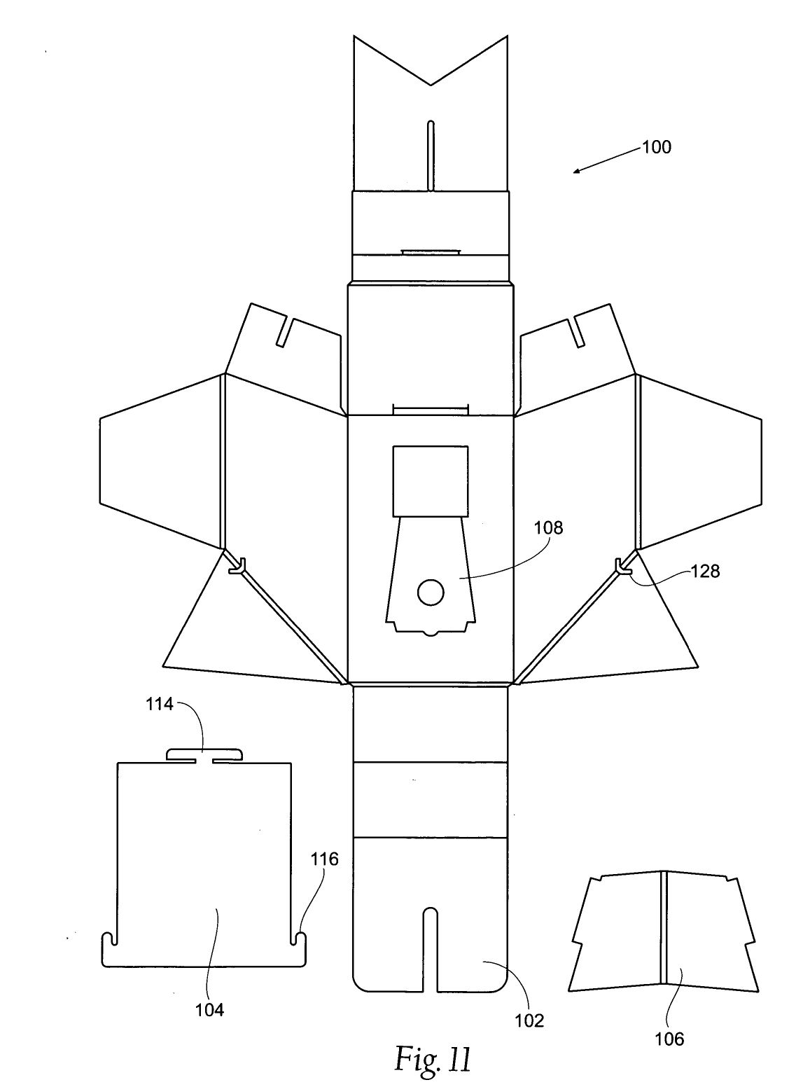

FIG. 10a is a ninth preferred embodiment of a front side of a baggage identification tag.

FIG. 10b is a ninth preferred embodiment of a rear side of a baggage identification tag.

FIG. 11 is a side view of a system of cut outs for creating the display container shown in FIG. 1.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

FIG. 1 is a perspective view of a container carrying baggage identification tags. FIG. 1. depicts a preferred embodiment of a pop up container 100 (shown in detail in FIG. 11) for preferably containing baggage identification tags 10. Said baggage identification tags 10 bear preferably on their front a carrier defined display zone, or branding area 22, and an advertising zone or area 14, separated by a fold/perforation line, shown dashed. The carrier defined display zone is preferably an indication of what airline (or other form of transportation) a passenger is flying on. The advertising zone or area 14 preferably bears an advertisement for a third party.

An entity will endeavor to obtain a willing and paying third party customer for placing an advertisement on said baggage identification tags 10 in the advertising zone 14. Because of the perforation, the advertising zone 14 may also comprise a 2-sided coupon. Said baggage identification tags 10 also advantageously display the advertising zone 14 to consumers approaching a ticketing counter. Also in a preferred embodiment, said baggage identification tags 10 will be housed in a conspicuous location, such as at an airline ticketing counter, and be housed in a preferred pop up container 100 for holding said baggage identification tags 10.

In a preferred embodiment, said pop up container 100 can comprise a self-mailable box already including said baggage identification tags (refer to FIG. 11). The self-mailable box 100 can then be shipped directly to the desired airport, and easily opened to reveal the baggage identification tags 10. The A pop up container 100 combines needs of airline check in desks and the conditions of a media vehicle for the advertising industry. The pop up container 100 is a functional dispenser and exhibition display for luggage name tags 10 with advertising, preferably positioned at individual check in desks. The pop up container 100 provides airlines with a custom branded, disposable, maintenance free, all in one pre-packaged dispenser for luggage name tags 10, adding organization, aesthetics to the check in desk while occupying minimal space and tolerating wear and bumps of counter transactions. The pop up container 100 also provides the advertising industry with effective exhibition of two sided advertising copies attached to luggage name tags 10.

Referring now to FIGS. 2a and 2b-10a and 10b, it is noted that the figs. A and B represent the front and back sides of the tags 10, respectively. The front and back sides share a common perforation line 18.

Referring now to FIG. 2a, a first preferred embodiment of a front side of a baggage identification tag 10 is shown. In this embodiment, the baggage identification tag 10 has on its front side a carrier defined branding area 22, a perforation separating the branding area 22 from the advertising area 14. A baggage attachment 20 is provided, for carrying a string or the like for attachment to luggage (not shown). A half-moon fold lip 16 is provided such that when the advertising area 14 is folded along the perforation line 18, the trailing edge (the right edge on FIG. 2a) can be tucked into the fold lip 16.

Referring now to FIG. 2b, a first preferred embodiment of a rear side of a baggage identification tag is shown. The rear size of the tag 10 also may carry an advertising area 14. When folded, the advertising area 14 on the rear side conceals the identity of the passenger, which is shown on the name zone 12 of the tag 10. Also, a passenger can rip off the advertising area 14 on both the front and rear sides for future reference, or for coupon redemption.

Referring now to FIG. 3a, a second preferred embodiment of a front side of a baggage identification tag 10 is shown. In this embodiment, the half-moon fold lip 16 has been replaced with corner cut fold lips 40, so that the opposing edge can be tucked into the fold lips 40 much in the same manner as the half-moon 16. Also, an additional fold/perforation line has been provided closer to the baggage attachment 20 so that if the advertising area 14 has been removed, the user can fold over the remainder of the tag 10, concealing the name of the passenger.

Referring now to FIG. 4a, a third preferred embodiment of a front side of a baggage identification tag is shown. In this side-by-side embodiment, the advertising area 14 and the carrier defined branding area 22 are in a stacked relationship, with half-moon fold lip 16 provided to conceal name zone 12, folded along a vertical perforation line, as opposed to the horizontal line depicted in FIGS. 2a and 2b.

Referring now to FIG. 5a, a fourth preferred embodiment of a front side of a baggage identification tag is shown, a keyhole embodiment. In this horizontal embodiment, a luggage extender 21 is provided to extend the remainder of the tag 10 away from the baggage. The advertising area 14 and the carrier defined branding area 22 are thus spaced apart from the luggage, but similarly labeled and foldable.

Referring now to FIG. 6a, a fifth preferred embodiment of a front side of a baggage identification tag is shown, a glued one-piece embodiment. In this embodiment, a glue strip is applied to a one piece fold over portion 16 on the rear side (FIG. 6b) so that the one piece fold over portion 16 may be glued to itself, creating a stronger 2 layer hold about the string carried in the string hole 20. Also, an additional fold/perforation line has been provided closer to the baggage attachment 20 so that if the advertising area 14 has been removed, the user can fold over the remainder of the tag 10, concealing the name of the passenger, and this portion can be glued within the fold over portion 16.

Referring now to FIG. 7a, a sixth preferred embodiment of a front side of a baggage identification tag is shown, a glued 2-piece embodiment. In this embodiment, the fold over portion 16 is detached from the tag 10, but glue applied with the fold over portion 16 is used to attach the fold over portion 16 to the tag as shown. Again, an additional fold/perforation line has been provided closer to the baggage attachment 20 so that if the advertising area 14 has been removed, the user can fold over the remainder of the tag 10, concealing the name of the passenger, and this portion can be glued within the fold over portion 16.

Referring now to FIGS. 8a-9b, a flange variation has been added to both the one piece and two piece glued embodiments depicted in FIGS. 6a-7b. In these embodiments, a ring flange 50 is provided to be used in conjunction with string hole 20, as a means for making the luggage attachment more robust.

Referring now to FIG. 10a, a ninth preferred embodiment of a front side of a baggage identification tag is shown, a stapled version, with the staple 52 replacing the function of the glue described in relation to previous embodiments.

Referring now to FIG. 11 is a side view of a system of cut outs for creating the display container 100 shown in FIG. 1 is shown. Advantages of the display container 100 include that it eliminates duplicated packaging cost for both dispensers and luggage name tags; eliminates duplicated inventory space for both dispensers and luggage name tags; adds self service luggage name tag dispenser feature to check in desks where none are available. Further, the display 100 eliminates counter maintenance of numerous loose luggage name tags; eliminates filling of numerous loose luggage name tags; and it creates an exclusive media space for direct and clear display of luggage name tags with advertising.

The container 100 is provided with a tear away shipping guard 102 which protects against warp of luggage name tags, and secures shipping position of loose materials. Prior to shipping, the container 100, if folded along the shown fold lines, will be self contained, and contain the tags 10. Following shipping, the user can tear away the shipping guard 102, and install the supplied transparent display face 104, to convert the dispenser to display to clearly exhibit the tags 10 and the advertisement 14. Next, the user can install the deep profiled pocket divider 106 to maintain organized dispensing of the tags 10. Next, a back support 108 is proved to provide a stable base that tolerates mobility and bumps.

The face 104 is preferably transparent to display the luggage tags 10 provided within. The face is preferably equipped with both a bottom slide lock 114 and a lens pinched notch lock 116 for coupling with the container 100, as shown in FIG. 1, and also on FIG. 11 at the lens side flare lock 128 (optional). The pocket divider 106 (FIG. 1) is provided so that both the front and the back of the tags 10 can be displayed within the container 100.

In a novel method for supplying said baggage identification tags and said pop up containers to airlines, an ambient sub-media advertising vehicle is provided, who can contract distribution and preferably no cost supplies of these materials to air carriers, and to package and sell the advertising space with individual advertisers and agencies, and provide for the convenient production and shipping of said baggage identification tags with said pop up containers.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention.

1. In combination with a pop-up display, a baggage identification tag comprising first side bearing a carrier defined display zone, and an advertising zone, a fold between said display zone and said advertising zone; and a second side bearing a passenger information zone.
